(19) United States
(12) Patent Application Publication
(10) Pub. No.: US 2025/0007281 A1
(43) Pub. Date: Jan. 2, 2025

(54) METHOD FOR CONTROLLING RECEIVING-END ALTERNATING CURRENT (AC) FAULT RIDE-THROUGH OF HYBRID CASCADED HIGH-VOLTAGE DIRECT-CURRENT (HVDC) TRANSMISSION SYSTEM

(71) Applicant: ZHEJIANG UNIVERSITY, Hangzhou, Zhejiang (CN)

(72) Inventors: Zheng XU, Hangzhou (CN); Nan ZHANG, Hangzhou (CN); Zheren ZHANG, Hangzhou (CN)

(73) Assignee: ZHEJIANG UNIVERSITY, Hangzhou, Zhejiang (CN)

(21) Appl. No.: 18/702,296

(22) PCT Filed: Jul. 26, 2022
(86) PCT No.: PCT/CN2022/107777

§ 371 Date: Apr. 17, 2024

(30) Foreign Application Priority Data
Apr. 21, 2022 (CN) 202210438734.2

(51) Int. Cl. H02J 3/00; H02J 3/36

(52) U.S. Cl. CPC H02J 3/001; H02J 3/36

(57) ABSTRACT

The present disclosure provides a method for controlling the receiving-end alternating-current (ac) fault ride-through of the hybrid cascaded high-voltage direct-current (hvdc) transmission system. According to the method, a line commutated converter (lcc) on the rectifier side determines the occurrence of a receiving-end ac fault based on a change in an electrical quantity of its dc port, and quickly reduces the dc voltage on the rectifier side by increasing the firing angle, so as to quickly suppress an overcurrent. The mmcs on the inverter side, which use the constant active power control, correct the outer-loop active power reference values to transmit as much active power as possible, thereby reducing the surplus power of the receiving-end system and suppressing an overvoltage for submodule capacitors of the mmcs.

This application claims priority to the Chinese Patent Application No. 202210438734.2, filed with the China National Intellectual Property Administration (CNIPA) on Apr. 21, 2022, and entitled “METHOD FOR CONTROLLING RECEIVING-END ALTERNATING-CURRENT (AC) FAULT RIDE-THROUGH OF HYBRID CASCADED HIGH-VOLTAGE DIRECT-CURRENT (HVDC) TRANSMISSION SYSTEM”, which is incorporated herein by reference in its entirety.

### TECHNICAL FIELD

The present disclosure relates to the technical field of a power system, and specifically, to a method for controlling receiving-end alternating-current (AC) fault ride-through of a hybrid cascaded high-voltage direct-current (HVDC) transmission system.

### BACKGROUND

A line commutated converter based high voltage direct current (LCC-HVDC) technology is already very mature and has advantages such as a low investment cost and rich practical experience. However, the LCC-HVDC technology also has problems such as the commutation failure in an inverter station, a need for sufficient reactive power support from an AC system, and an inability to transmit power to a weak AC system. In contrast, a modular multilevel converter based HVDC (MMC-HVDC) technology not only has no commutation failure and reactive power compensation problem, but also can independently adjust both active and reactive power simultaneously. However, compared with the LCC-HVDC technology, the MMC-HVDC technology has disadvantages of a high device cost, a large loss, and a weak overload capacity.

To make advantages of both LCC and MMC, the hybrid HVDC transmission technology has become a new research hotspot and a development trend for long-distance and high-capacity transmission in the future. The Baihetan-Jiangsu hybrid cascaded HVDC transmission project currently under construction in China uses the LCC for a rectifier side. The receiving end adopts a LCC in series with three paralleled MMCs. The receiving-end AC systems of the LCC and three MMCs are distributed load centers respectively, forming a multi-infeed HVDC system. However, because load centers in eastern China are relatively close to each other, there is inevitably different electrical coupling in receiving-end AC systems of the load centers. This project has achieved long-distance and high-capacity hydropower transmission in the western region, thereby alleviating power shortages in the eastern region.

When a serious fault occurs on the receiving-end AC system, the LCC on the inverter side may experience a commutation failure, and power transmission of the MMC may also be blocked, which may cause an overcurrent and an overvoltage to the system. Once the LCC on the inverter side experiences the commutation failure, the DC voltage of the inverter LCC drops to zero, and a significant DC voltage difference between sending and receiving ends will cause a sharp increase in the DC current. In addition, due to a slow control response speed of the LCC on the rectifier side, the receiving end will bear huge surplus power, forcing submodules in the MMC to be overcharged. As a result, an overvoltage is caused to submodule capacitors. In addition, a decrease in a receiving-end AC voltage will weaken the power transmission capacity of the MMC, resulting in a larger power imbalance between the sending and receiving ends, and exacerbating an overvoltage level. The overcurrent and the overvoltage that are caused by the fault of the receiving-end AC system affect insulation and a service life of the devices, and even cause device damage, and other faults.

Regarding receiving-end AC fault ride-through of a hybrid cascaded HVDC transmission system, existing research has mostly focused on use of an energy dissipation device to suppress the overvoltage. For example, in the literature [CHENG F, YAO L, XU J, et al. A comprehensive ac fault ride-through strategy for hvdc link with serial-connected lcc-vsc hybrid inverter [J]. CSEE Journal of Power and Energy Systems, 2022, 8(1): 175-187.], a receiving-end AC fault ride-through measure for suppressing the DC overvoltage based on a DC chopper is proposed. In the literature [Liu Zehong, Wang Shaowu, Zhong Zhiyi, et al. Controllable and Self-recovery Energy Absorbing Device for Receiving-end Hybrid UHVDC Transmission System [J] Proceedings of the CSEE, 2021, 41 (02): 514-524.], a controllable and self-recovery energy absorbing device is proposed, which is installed in parallel on a ±400 kV DC bus of a DC port of the MMC to dissipate transient surplus power of the system in the case of a receiving-end AC fault. However, the above-mentioned auxiliary energy-absorbing device requires a high investment cost, and long-term energy-absorbing can accelerate the aging of arresters.

Therefore, there is currently a lack of research on a suppression strategy for the overcurrent caused by the fault in the receiving-end AC system of the hybrid cascaded HVDC transmission system. In the literature [NIU C, Yang M, XUE R, et al. Research on inverter side ac fault ride-through strategy for hybrid cascaded multi-terminal hvdc system[C]. 2020 IEEE 4th Conference on Energy Internet and Energy System Integration (EI2), 2020: 800-805.], a control strategy is proposed. According to the control strategy, under normal inter-station communication, after the LCC on the rectifier side receives a signal indicating that a fault occurs at the receiving-end AC system, the constant DC control is switched to a PI controller with a faster response speed, and the DC current is quickly reduced by decreasing its reference value. However, the speed of the inter-station communication is slow, and a too-low current reference value increases a power loss during the fault and prolongs fault recovery time.

### SUMMARY

In view of the above content, the present disclosure provides a method for receiving-end AC fault ride-through of a hybrid cascaded HVDC transmission system, to overcome a problem of an insufficient capability of AC fault riding-through and suppress an overcurrent and an overvoltage.

A method for controlling receiving-end AC fault ride-through of a hybrid cascaded HVDC transmission system is provided, where the hybrid cascaded HVDC transmission system adopts an LCC on a rectifier side and an LCC-MMC hybrid cascaded structure on an inverter side, where the LCC-MMC hybrid cascaded structure is constituted by connecting parallel MMCs to the LCC in series. When a commutation failure occurs on the LCC on the inverter side due to a serious receiving-end AC fault, the LCC on the rectifier side determines occurrence of the receiving-end AC fault based on a change in an electrical quantity of a DC port of the LCC on the rectifier side, and then quickly reduces a DC voltage and DC transmission power on the rectifier side by increasing its firing angle; and MMCs on the inverter side, which use constant active power control, correct values of their outer-loop active power references to transmit as much active power as possible, thereby suppressing an overcurrent and an overvoltage to ride through the receiving-end AC fault.

Further, the method for controlling receiving-end AC fault ride-through includes the following specific steps:
(1) during steady-state operation, using constant DC current control for the LCC on the rectifier side, using constant DC voltage control for the LCC on the inverter side, and controlling the MMCs on the inverter side in a master-slave manner, specifically, using the constant DC voltage control and constant reactive power control for one of the MMCs, using the constant active power control and the constant reactive power control for the other MMCs;
(2) determining, on the rectifier side, whether an AC fault of a receiving-end power grid occurs in the system; and if the AC fault occurs, removing a DC line protection device of the system to avoid its misoperation;
(3) quickly increasing a firing angle reference value of the LCC on the rectifier side to α*_{cal} to reduce the DC voltage and the DC transmission power on the rectifier side;
(4) for the MMCs using the constant active power and the constant reactive power, calculating correction values of the outer-loop active power references and adding the correction values to their original values; and
(5) after receiving a signal for removing the AC fault of the receiving-end power grid through inter-station communication on the rectifier side, putting the DC line protection device into operation, and reducing the firing angle reference value of the LCC on the rectifier side from a to a steady-state value to enable the system to smoothly recover to a steady state.

In the step (2), when a DC current on the rectifier side is greater than 1.1 p.u. and the DC voltage on the rectifier side is between 0.5 p.u. and 0.9 p.u., it is determined that the AC fault of the receiving-end power grid occurs in the system.

Further, a calculation expression for the firing angle reference value α*_{cal} is as follows:

$${α}_{cal}^{*} *= arccos ( \frac{{U}_{dcr}^{′} + \frac{3}{π} {X}_{r} {I}_{d c}^{*}}{\frac{12 \sqrt{2}}{π} {U}_{r}} )$$

where Uᵣ represents an amplitude of an AC voltage on the rectifier side, Xᵣ represents commutation reactance of the LCC on the rectifier side, U′_{der} represents a theoretical DC voltage of the LCC on the rectifier side, and I*_{dc} represents a reference value of the DC current of the LCC on the rectifier side.

Preferably, the theoretical DC voltage U′_{der} of the LCC on the rectifier side is set to 0.5 p.u.

Further, a calculation expression for the correction value of the outer-loop active power reference is as follows:

$$Δ {P}_{s}^{*} = \frac{( {U}_{dci , MMC} {I}_{dci} - {\sum }_{i = 1}^{n} {P}_{s , {MMC}_{i}} )}{( n - 1 ) {S}_{N}}$$

where ΔP*ₛ represents the correction value of the outer-loop active power reference, U_{dci,MMC} represents a DC voltage of each MMC, I_{dci} represents a DC current on the inverter side, P_{s,MMCi} represents instantaneous output active power of an i^{th} MMC on the inverter side, S_{N} represents a rated capacity of each MMC, and n represents the number of MMCs on the inverter side.

Further, a calculation expression for the instantaneous output active power P_{s,MMCi} is as follows:

$${P}_{s , {MMC}_{i}} = \frac{3}{2} {U}_{s m , {MMC}_{i}} {i}_{vd , {MMC}_{i}}$$

where U_{sm,MMCi} represents a grid-side phase voltage amplitude of the i^{th} MMC on the inverter side, and i_{vd,MMCi} represents a d-axis component of a valve-side current amplitude of the i^{th} MMC on the inverter side.

According to the present disclosure, in the hybrid cascaded HVDC transmission system with the sending-end LCC and the receiving-end cascaded LCC-MMC, when the commutation failure occurs on the LCC on the inverter side due to the serious receiving-end AC fault, the LCC on the rectifier side determines the occurrence of the receiving-end AC fault based on the change in the electrical quantity of the DC port of the LCC on the rectifier side, and quickly reduces the DC voltage by increasing the firing angle, so as to quickly suppress the overcurrent. Correspondingly, the HVDC transmission power on the rectifier side is also reduced. In addition, the present disclosure enables the MMCs on the inverter side, which use the constant active power control, to correct the values of the outer-loop active power references of the MMCs to transmit as much active power as possible, thereby reducing surplus power of the receiving-end system and suppressing an overvoltage for submodule capacitors of the MMCs. In this way, the receiving-end AC fault of the LCC-MMC hybrid cascaded HVDC transmission system is ridden through.

Compared with the prior art, the present disclosure has following beneficial technical effects:
1. According to the method in the present disclosure, after the receiving-end AC fault occurs in the hybrid cascaded HVDC transmission system with the sending-end LCC and the receiving-end cascaded LCC-MMC, the sending end does not need to rely on the inter-station communication and has a faster response speed.
2. The method in the present disclosure proposes, from a control perspective, a suppression measure for an overcurrent and an overvoltage in the case of a receiving-end power grid fault of the hybrid cascaded HVDC transmission system with the sending-end LCC and the receiving-end cascaded LCC-MMC, achieving fault ride-through, reducing energy absorption of arresters, and providing guarantee for safe and stable operation of the HVDC system.

### BRIEF DESCRIPTION OF THE DRAWINGS

FIG. 1 is a diagram of a topology of a hybrid cascaded HVDC transmission system;

FIG. 2 is a principle diagram of the improved control of the LCC on a rectifier side according to the present disclosure;

FIG. 3 is a principle diagram of correcting and controlling the outer-loop active power of MMCs on the inverter side according to the present disclosure;

FIG. 4 schematically shows a waveform of the effective AC voltage of each receiving-end power grid in the case of a three-phase short-circuit fault of a receiving-end AC system of MMC₁ in the example;

FIG. 5 schematically shows a waveform of the valve-side current of the converter transformer of the LCC on an inverter side in the case of a three-phase short-circuit fault of a receiving-end AC system of MMC₁ in the example;

FIG. 6 schematically shows a waveform of the DC current on a rectifier side in the case of a three-phase short-circuit fault of a receiving-end AC system of MMC₁ in the example;

FIG. 7 schematically shows a waveform of the DC voltage on a rectifier side in the case of a three-phase short-circuit fault of a receiving-end AC system of MMC₁ in the example;

FIG. 8 schematically shows a waveform of the firing angle of the LCC on the rectifier side in the case of a three-phase short-circuit fault of a receiving-end AC system of MMC₁ in the example;

FIG. 9 schematically shows a waveform of the active power of MMC₃ in the case of a three-phase short-circuit fault of a receiving-end AC system of MMC₁ in the example; and

FIG. 10 schematically shows a waveform of the voltage of submodule capacitors of MMC₁ in the case of a three-phase short-circuit fault of a receiving-end AC system of MMC₁ in the example.

### DETAILED DESCRIPTION OF THE EMBODIMENTS

To more specifically describe the present disclosure, the technical solution of the present disclosure is described in detail below with reference to the accompanying drawings and specific implementations.

A method for controlling receiving-end AC fault ride-through of the hybrid cascaded HVDC transmission system in the present disclosure includes following steps:
(1) During steady-state operation, the LCC on the rectifier side uses the constant DC current control, the LCC on the inverter side LCC uses the constant DC voltage control, and n MMCs on the inverter side are controlled in a master-slave manner, specifically, MMC₁ uses the constant DC voltage control and the constant reactive power control, and the remaining MMCₓ (x=2, 3, . . . , n) uses the constant active power control and the constant reactive power control.
(2) When the DC current on the rectifier side is greater than 1.1 p.u. and the DC voltage on the rectifier side is between 0.5 p.u. and 0.9 p.u., determine that an AC fault of a receiving-end power grid occurs in the hybrid cascaded HVDC transmission system.

When a commutation failure occurs on the LCC on the inverter side due to a serious AC fault of the receiving-end power grid, it is equivalent that the DC side of the inverter LCC is short-circuited (specifically, its DC voltage is zero), and the DC voltage on the inverter side rapidly decreases. A DC voltage difference between the rectifier side and the inverter side causes an increase in the DC current. In a fault detection module on the rectifier side, when the DC current on the rectifier side is greater than 1.1 p.u., and the DC voltage on the rectifier side is between 0.5 p.u. and 0.9 p.u., it is determined that the AC fault of the receiving-end power grid occurs in the system. In this case, DC line protection is disabled to avoid a misoperation.
(3) Quickly increase the firing angle reference value of the LCC on the rectifier side to α*_{cal} to reduce the DC voltage and the DC transmission power on the rectifier side.

Expressions of the DC voltage U_{der} and the DC transmission power P_{der} of the LCC on the rectifier side are as follows:

$${U}_{dcr} = 4 ( \frac{3 \sqrt{2}}{π} {U}_{r} cos {α}_{r} - \frac{3}{π} {X}_{r} {I}_{d c} ) ; and$$

$${P}_{dcr} = {U}_{dcr} {I}_{d c} .$$

In the above expressions, Uᵣ represents an amplitude of the AC voltage on the rectifier side, αᵣ represents the firing angle of the LCC on the rectifier side, Xᵣ represents the commutation reactance of the LCC on the rectifier side, and I_{dc} represents the DC of the LCC on the rectifier side.

The above expressions show that the value of the U_{der} depends on the αᵣ and the I_{dc}. Compared with the adjustment of the DC reference value, adjustment of the firing angle reference value has a faster response speed, and a too low current reference value may increase a power loss during the fault and prolong fault recovery time. Therefore, the DC reference value is set to a constant value, and the DC voltage on the rectifier side is reduced by increasing the firing angle reference value. It should be noted that theoretically, the DC voltage of the LCC on the inverter side drops to 0, and the DC voltage on the entire inverter side drops to 0.5 p.u. However, the receiving-end AC voltage drops more greatly, power output of the MMC is blocked, a power imbalance between sending and receiving ends is larger, and an overvoltage is larger for submodule capacitors of the MMCs is larger. This causes a higher DC voltage on the inverter side. In fact, the DC voltage on the entire inverter side is higher than 0.5 p.u. Therefore, in order to ensure that the receiving end can send out all absorbed DC power to suppress an overvoltage for the submodules, it is assumed the U_{der} is a constant and set to a theoretical value of 0.5 p.u. Under such assumption, α*_{cal} can be calculated:

$${α}_{cal}^{*} *= arccos ( \frac{{U}_{dcr}^{′} + \frac{3}{π} {X}_{r} {I}_{d c}^{*}}{\frac{12 \sqrt{2}}{π} {U}_{r}} ) .$$

In the above formula, I*_{dc} represents the DC reference value of the LCC on the rectifier side, and U′_{der} represents the theoretical DC voltage of the LCC on the rectifier side.
(4) Calculate a correction value ΔP*ₛ of an outer-loop active power reference of the MMCₓ (x=2, 3, . . . , n) on the inverter side, and add the correction value to an original value P*ₛ of the active power reference to ensure that the inverter side outputs more active power.

During normal operation, ΔP_{s*}=0, with an adjustable range being [0, S_{N}−P*ₛ], where S_{N} represents the rated capacity of each MMC. When the AC fault of the receiving-end power grid occurs, instantaneous output active power P_{s,MMCi} of an MMCᵢ (i=1, 2, . . . , n) is expressed as follows:

$${P}_{s , {MMC}_{i}} = \frac{3}{2} {U}_{s m , {MMC}_{i}} {i}_{vd , {MMC}_{i}} .$$

In the above expression, U_{sm,MMCi} represents the grid-side phase voltage amplitude of the MMCᵢ, and i_{vd,MMCi} represents the d-axis component of the valve-side current amplitude of the MMCᵢ.

Therefore, the following can be obtained:

$$Δ {P}_{s}^{*} = \frac{( {U}_{dci , MMC} {I}_{dci} - {\sum }_{i = 1}^{n} {P}_{s , {MMC}_{i}} )}{( n - 1 ) {S}_{N}} .$$

In the above formula, U_{dci,MMC} represents the DC voltage of the MMC, and I_{dci} represents the DC current on the inverter side.
(5) After receiving a signal for removing the AC fault of the receiving-end power grid through inter-station communication on the rectifier side, enable the DC line protection, and linearly reduce the firing angle reference value of the LCC on the rectifier side from α*_{cal} to the steady-state value to lower a recovery speed of the DC voltage, so as to enable the hybrid cascaded HVDC transmission system to smoothly recover to a steady state.

After the receiving-end AC fault is cleared, the sending end can only respond after a delay of the inter-station communication. Although the communication and reducing the firing angle prolong a recovery process to a certain extent, fault recovery performance of the entire system is improved, such that the system can transition more smoothly to the steady state.

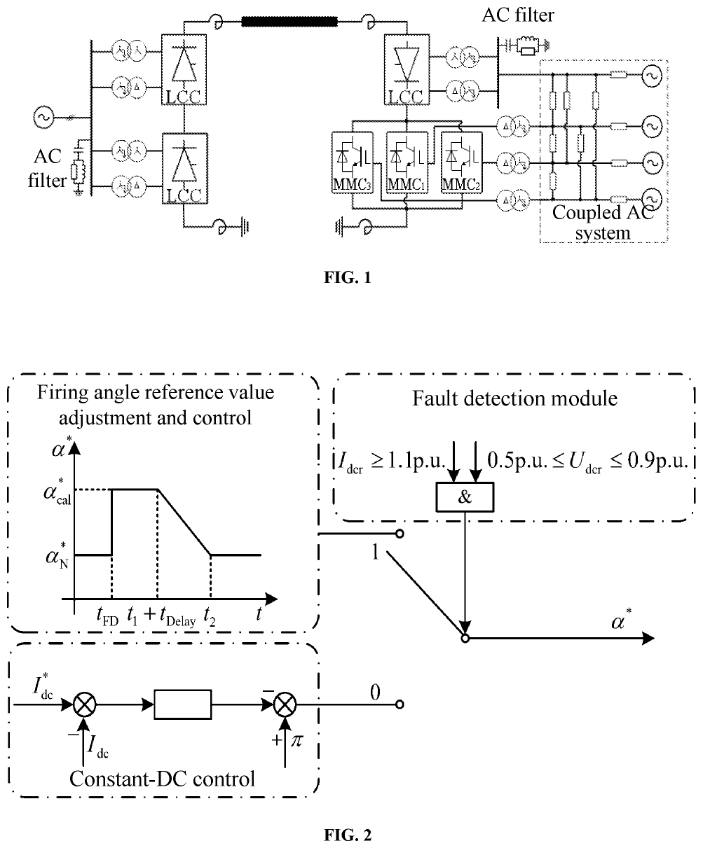

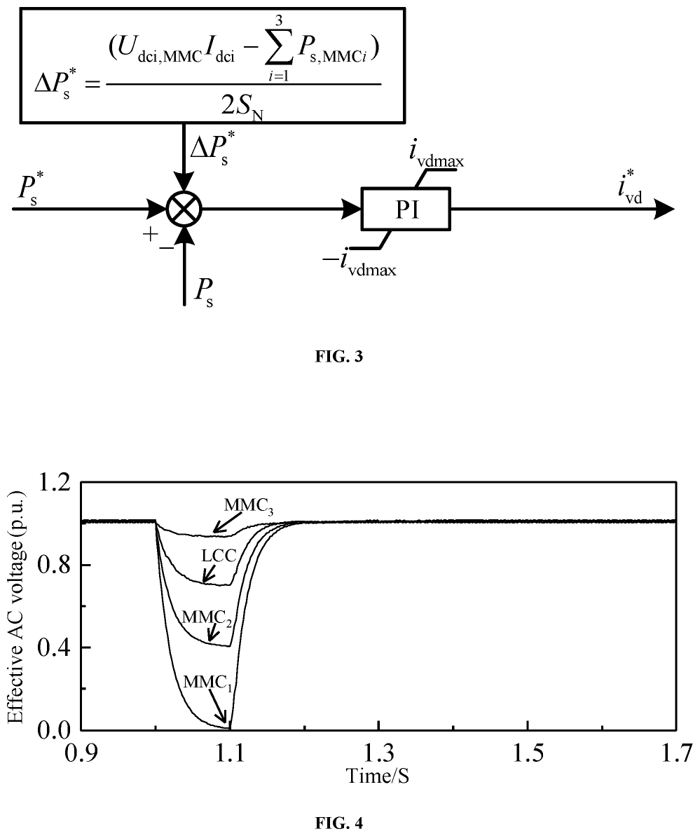

As shown in FIG. 1, this implementation takes the hybrid cascaded HVDC transmission system with a sending-end LCC and a receiving-end cascaded LCC-MMC as an example. Specifically, an LCC is adopted for a rectifier side. The inverter side adopts a LCC in series with three paralleled MMCs. The LCC and the three MMCs on the inverter side are connected to different receiving-end AC systems, and there is electrical coupling between the different receiving-end AC systems. When a commutation failure occurs on the LCC on the inverter side due to a serious receiving-end AC fault, the LCC on the rectifier side determines the occurrence of the receiving-end AC fault based on a change in the electrical quantity of its DC port, and then quickly reduces the DC voltage and the DC transmission power on the rectifier side by increasing the firing angle. In addition, MMC₂ and MMC₃ on the inverter side, which use the constant active power control, correct values of their outer-loop active power references to transmit as much active power as possible, thereby suppressing an overcurrent and an overvoltage to ride through the receiving-end AC fault. A specific control process is as follows:
(1) During the steady-state operation, the LCC on the rectifier side uses the constant DC current control, and the LCC on the inverter side uses the constant DC voltage control. Three MMCs on the inverter side are controlled in a master-slave manner, specifically, MMC₁ uses the constant DC voltage control and the constant reactive power control, and MMC₂ and MMC₃ use the constant active power control and the constant reactive power control.
(2) When the DC current on the rectifier side is greater than 1.1 p.u. and the DC voltage on the rectifier side is between 0.5 p.u. and 0.9 p.u., as shown in FIG. 2, a fault detection module determines that an AC fault of a receiving-end power grid occurs in the hybrid cascaded HVDC transmission system, and switches the mode to 1. In this case, DC line protection is disabled to avoid a misoperation.
(3) Quickly increase the firing angle reference value of the LCC on the rectifier side to a*_{cal}, as shown in FIG. 2, so as to reduce the DC voltage and the DC transmission power on the rectifier side.
(4) Calculate correction values ΔP*ₛ of the outer-loop active power references of MMC₂ and MMC₃ on the inverter side according to FIG. 3, and add the correction values to the original values P*ₛ of the active power references.
(5) After receiving a signal for removing the AC fault of the receiving-end power grid through inter-station communication on the rectifier side, enable the DC line protection, and linearly reduce the firing angle reference value of the LCC on the rectifier side from α*_{cal} to a steady-state value α*_{N}, as shown in FIG. 2, so as to enable the hybrid cascaded HVDC transmission system to smoothly recover to a steady state.

Based on FIG. 1, the parameters of the hybrid cascaded HVDC transmission system with the sending-end LCC and the receiving-end cascaded LCC-MMC under this implementation are shown in Table 1:

TABLE 1

| Parameter | | Value |
|---|---|---|
| Basic parameters of the system | Rated capacity/MW | 4000 |
| | Rated DC voltage/kV | 800 |
| | Rated DC current/kA | 5 |
| | Effective AC voltage/kV | 525 |
| | Short-circuit ratio of an AC system | 6 |
| | Inductance of a smoothing reactor/mH | 150 |
| MMC parameters | Rated capacity/MVA | 1000 |
| | Rated active power/MW | 667 |
| | Number of submodules per bridge arm | 200 |
| | Submodule capacitance/kV | 20 |
| | Submodule capacitance/μF | 16.67 |
| | Inductance of a bridge arm/mH | 25.33 |
| Parameters of the transformer of | Winding type | Y0/Y, Y0/Δ |
| the LCC on the rectifier side | No-load voltage ratio/kV | 525/179.75 |
| | Capacity/MVA | 1200 |
| | Leakage reactance/p.u. | 0.19 |
| Parameters of the transformer of | Winding type | Y0/Y, Y0/Δ |
| the LCC on the inverter side | No-load voltage ratio/kV | 510/161.50 |
| | Capacity/MVA | 1200 |
| | Leakage reactance/p.u. | 0.18 |
| Parameters of the transformer of | Winding type | Y0/Δ |
| the MMC | No-load voltage ratio/kV | 510/210 |
| | Capacity/MVA | 1125 |
| | Leakage reactance/p.u. | 0.15 |
| Parameters of a DC line | Line length/km | 2172 |
| | Resistance per unit line length/Ω · km⁻¹ | 0.00543 |
| | Reactance per unit line length/mH · km⁻¹ | 0.80787 |
| | Capacitance per unit line length/μF · km⁻¹ | 0.01409 |

The following verifies the effectiveness of the control strategy of the present disclosure by simulating a three-phase short-circuit-to-ground fault in the AC system of the receiving-end MMC₁.

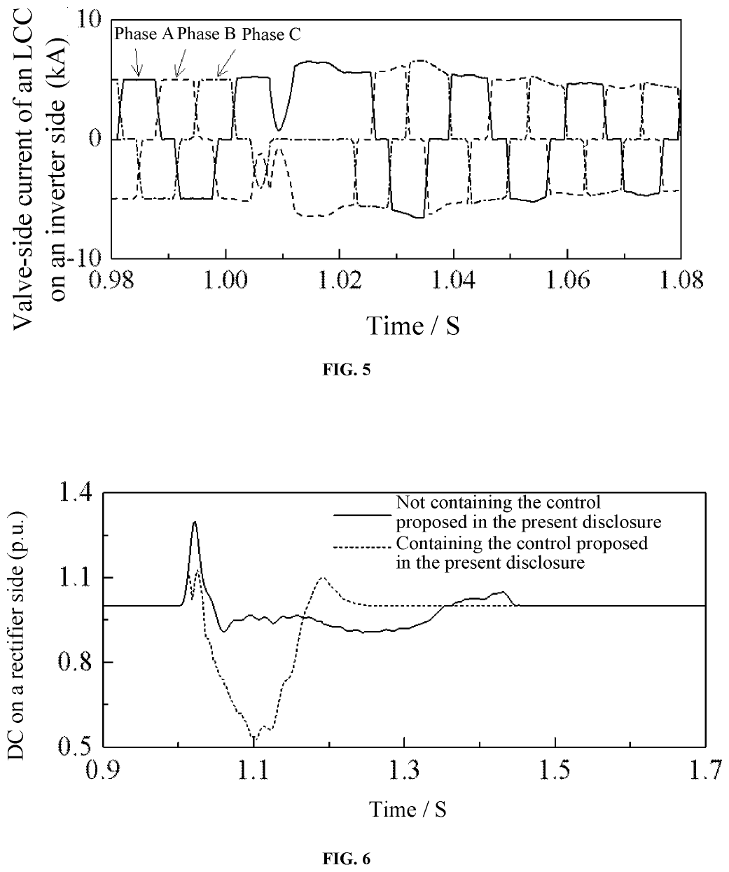

Assuming that at t=1 s, the three-phase short-circuit-to-ground fault occurs in the AC system of the receiving-end MMC₁, it can be seen from FIG. 4 that the effective voltages of AC buses of the receiving-end LCC, MMC₁, MMC₂, and MMC₃ drop differently due to varying degrees of electrical coupling in the AC systems. It can be seen from FIG. 5 that the commutation failure occurs on the LCC on the inverter side, and the DC voltage of the LCC on the inverter side drops to zero, resulting in a large DC voltage difference between the rectifier side and the inverter side. As a result, the hybrid cascaded HVDC transmission system generates an overcurrent. In addition, active power output by the LCC is 0, and output of active power of the three MMCs is also blocked differently due to varying AC voltage drops of the three MMCs. A power imbalance between sending and receiving ends causes the receiving-end MMCs to bear large surplus power, forcing the submodule capacitors to be charged, and even generating an overvoltage.

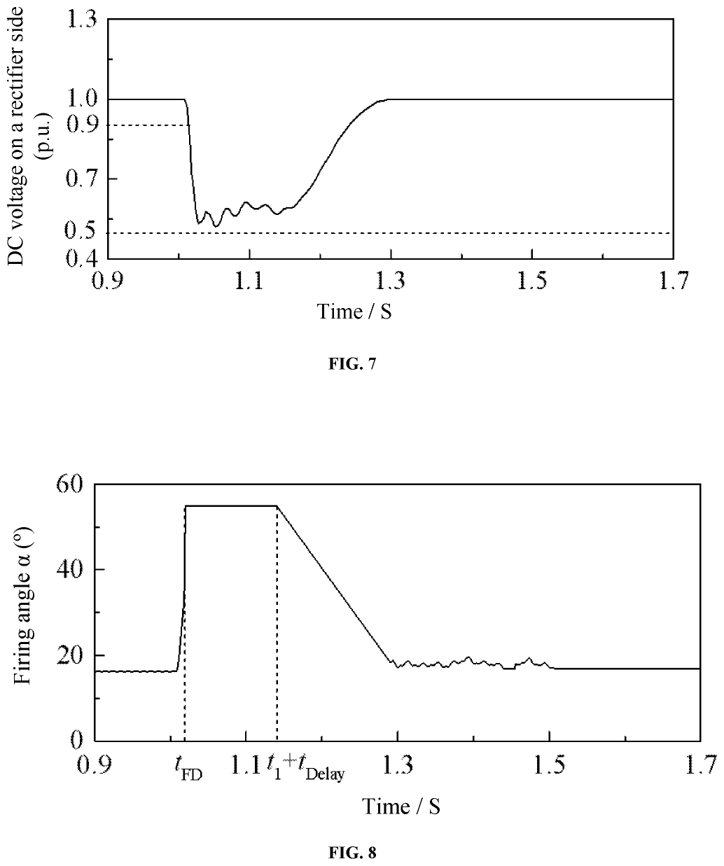

After this implementation is adopted, response curves of the DC current and the DC voltage on the rectifier side are shown in FIG. 6 and FIG. 7 respectively. FIG. 8 shows the response curve of the firing angle of the LCC on the rectifier side. The above figures show that after the three-phase short-circuit-to-ground fault occurs in the AC system of the receiving-end MMC₁, when the fault detection module detects that the DC current on the rectifier side is greater than 1.1 p.u. and the DC voltage on the rectifier side is between 0.5 p.u. and 0.9 p.u. (specifically, t=t_{FD}), the LCC on the rectifier side rapidly increases the firing angle reference value to α*_{cal}. In this case, a peak value of the DC current on the rectifier side is only 1.13 p.u., which is much lower than 1.31 p.u. obtained without the proposed control in the present disclosure. Compared with that time during which the DC current on the rectifier side exceeds 1.1 p.u. is 22 ms without the proposed control in this implementation, time during which the DC current on the rectifier side exceeds 1.1 p.u. is only 8 ms when the control is this implementation is performed.

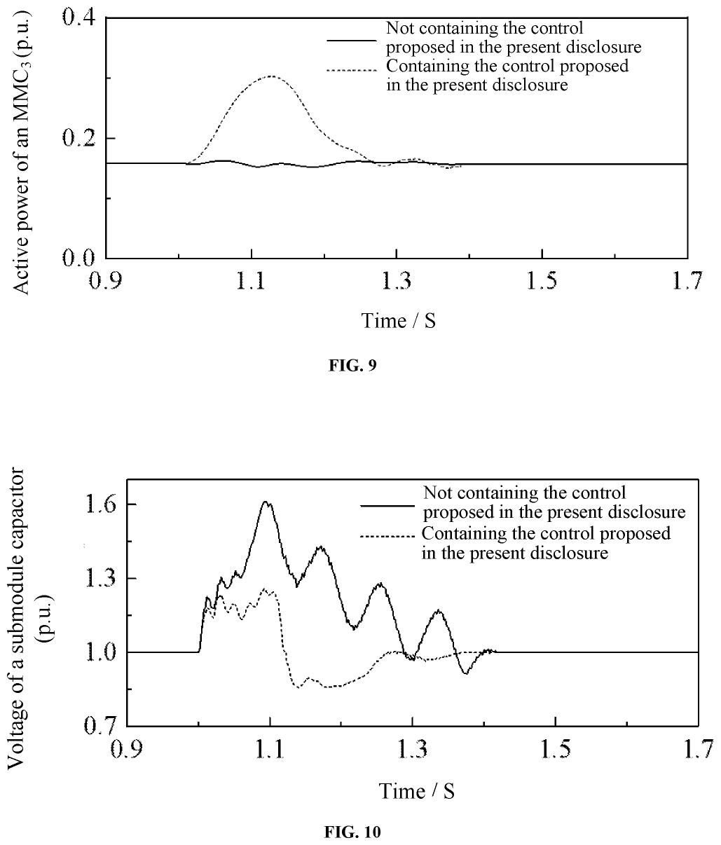

As shown in FIG. 9, the MMC₃ can emit more active power by correcting the value of the outer-loop active power reference, thereby reducing the surplus power on the MMCs. As shown in FIG. 10, a peak voltage of the submodule capacitors is reduced to 1.25 p.u., which is much lower than the 1.61 p.u. obtained without the proposed control in the present disclosure, thereby effectively suppressing the overvoltage for the submodule capacitors of the MMCs, and riding through the receiving-end AC fault of the hybrid cascaded HVDC transmission system. After the LCC on the rectifier side receives the signal for removing the AC fault of the receiving-end power grid through the inter-station communication, the firing angle reference value of the LCC on the rectifier side is linearly reduced from α*_{cal} to the steady-state value α*_{N}, as shown in FIG. 8, so as to enable the hybrid cascaded HVDC transmission system to smoothly recover to the steady state.

The above description of the embodiments is intended to facilitate a person of ordinary skill in the art to understand and use the present disclosure. Obviously, a person skilled in the art can easily make various modifications to these embodiments, and apply a general principle described herein to other embodiments without creative efforts. Therefore, the present disclosure is not limited to the embodiments herein. All improvements and modifications made by a person skilled in the art according to the disclosure of the present disclosure should fall within the protection scope of the present disclosure.

What is claimed is:

1. A method for controlling receiving-end alternating-current (AC) fault ride-through of a hybrid cascaded high-voltage direct-current (HVDC) transmission system, wherein the hybrid cascaded HVDC transmission system adopts a line commutated converter (LCC) on a rectifier side and a line commutated converter-modular multilevel converter (LCC-MMC) hybrid cascaded structure on an inverter side, wherein the LCC-MMC hybrid cascaded structure is constituted by connecting parallel MMCs to the LCC in series; when a commutation failure occurs on the LCC on the inverter side due to a serious receiving-end AC fault, the LCC on the rectifier side determines occurrence of the receiving-end AC fault based on a change in an electrical quantity of its DC port, and then quickly reduces a DC voltage and DC transmission power on the rectifier side by increasing a firing angle; and MMCs on the inverter side, which use constant active power control, correct values of their outer-loop active power references to transmit as much active power as possible, thereby suppressing an overcurrent and an overvoltage to ride through the receiving-end AC fault.

2. The method for controlling receiving-end AC fault ride-through according to claim 1, wherein the control method specifically comprises the following steps:
(1) during steady-state operation, using constant DC current control for the LCC on the rectifier side, using constant DC voltage control for the LCC on the inverter side, and controlling the MMCs on the inverter side in a master-slave manner, specifically, using the constant DC voltage control and constant reactive power control for one of the MMCs, and using the constant active power control and the constant reactive power control for the other MMCs;
(2) determining, on the rectifier side, whether an AC fault of a receiving-end power grid occurs in the system; and if the AC fault occurs, removing a DC line protection device of the system to avoid its misoperation;
(3) quickly increasing a firing angle reference value of the LCC on the rectifier side to α*_{cal} to reduce the DC voltage and the DC transmission power on the rectifier side;
(4) for the MMCs using the constant active power control and the constant reactive power control, calculating correction values of the outer-loop active power references and adding the correction values to their original values; and
(5) after receiving a signal for removing the AC fault of the receiving-end power grid through inter-station communication on the rectifier side, putting the DC line protection device into operation, and reducing the firing angle reference value of the LCC on the rectifier side from α*_{cal} to a steady-state value to enable the system to smoothly recover to a steady state.

3. The method for controlling receiving-end AC fault ride-through according to claim 2, wherein in the step (2), when a DC current on the rectifier side is greater than 1.1 p.u. and the DC voltage on the rectifier side is between 0.5 p.u. and 0.9 p.u., it is determined that the AC fault of the receiving-end power grid occurs in the system.

4. The method for controlling receiving-end AC fault ride-through according to claim 2, wherein a calculation expression for the firing angle reference value α*_{cal} is as follows:
$${α}_{cal}^{*} *= arccos ( \frac{{U}_{dcr}^{′} + \frac{3}{π} {X}_{r} {I}_{d c}^{*}}{\frac{12 \sqrt{2}}{π} {U}_{r}} )$$
wherein Uᵣ represents an amplitude of an AC voltage on the rectifier side, Xᵣ represents commutation reactance of the LCC on the rectifier side, U′_{der} represents a theoretical DC voltage of the LCC on the rectifier side, and I′_{dc} represents a reference value of the DC current of the LCC on the rectifier side.

5. The method for controlling receiving-end AC fault ride-through according to claim 4, wherein the theoretical DC voltage U′_{der} of the LCC on the rectifier side is set to 0.5 p.u.

6. The method for controlling receiving-end AC fault ride-through according to claim 2, wherein a calculation expression for the correction value of the outer-loop active power reference is as follows:
$$Δ {P}_{s}^{*} = \frac{( {U}_{dci , MMC} {I}_{dci} - {\sum }_{i = 1}^{n} {P}_{s , {MMC}_{i}} )}{( n - 1 ) {S}_{N}}$$
wherein ΔP*ₛ represents the correction value of the outer-loop active power reference, U_{dci,MMC} represents a DC voltage of each MMC, I_{dci} represents a DC current on the inverter side, P_{s,MMCi} represents instantaneous output active power of an i^{th} MMC on the inverter side, S_{N} represents a rated capacity of each MMC, and n represents the number of MMCs on the inverter side.

7. The method for controlling receiving-end AC fault ride-through according to claim 6, wherein a calculation expression for the instantaneous output active power P_{s,MMCi} is as follows:
$${P}_{s , {MMC}_{i}} = \frac{3}{2} {U}_{s m , {MMC}_{i}} {i}_{vd , {MMC}_{i}}$$
wherein U_{sm,MMCi} represents a grid-side phase voltage amplitude of the i^{th} MMC on the inverter side, and i_{vd,MMCi} represents a d-axis component of a valve-side current amplitude of the i^{th} MMC on the inverter side.
